(19) United States
(12) Patent Application Publication
(10) Pub. No.: US 2015/0229512 A1
(43) Pub. Date: Aug. 13, 2015

(54) PROPAGATION OF NETWORK CONFIGURATION UPDATE FROM NETWORK MANAGER TO NETWORK NODES USING ROUTING PROTOCOL

(71) Applicants: Enrico Dutti, Livorno (IT); Daniele Ceccarelli, Genova (IT); Silvia Pucci, Pisa (IT)

(72) Inventors: Enrico Dutti, Livorno (IT); Daniele Ceccarelli, Genova (IT); Silvia Pucci, Pisa (IT)

(73) Assignee: TELEFONAKTIEBOLAGET L M ERICSSON (PUBL), Stockholm (SE)

(21) Appl. No.: 14/404,626

(22) PCT Filed: Jun. 8, 2012
(86) PCT No.: PCT/EP2012/060882

§ 371 Date: Apr. 29, 2015

(51) Int. Cl. H04L 12/24; H04L 12/26

(52) U.S. Cl. CPC H04L 41/082; H04L 41/0853; H04L 43/065

(57) ABSTRACT

A method in a node of a network comprises the steps of receiving a configuration command signal, the configuration command signal indicating that one or more configuration parameters are to be changed in the node and at least one other node of the network. A routing protocol message is modified to include the configuration command signal. The configuration command signal is communicated to the at least one other node of the network using the modified routing protocol message.

### TECHNICAL FIELD

The present invention relates to a method and node for a network, and in particular a method and node for enabling one or more configuration parameters to be updated in a node of a network.

### BACKGROUND

In networks such as telecommunication networks, there is a requirement to change certain configuration parameters in many or all of the nodes of the network. It is often desirable to change such configuration parameters as quickly as possible, because having a situation whereby the same configuration parameters have different values on different nodes can lead to a dangerous network behavior, such as the inability to reroute traffic when a network fault is detected.

FIG. 1 shows one known method of updating configuration parameters of nodes 11₁ to 11_{N} in a network 10, using a Network Management System (NMS) 13. The NMS 13 contacts all of the nodes 11₁ to 11_{N} one by one via a Management Connection Network (MCN, not shown). The MCN is part of a Data Communication Network (DCN) dedicated to a management plane, and uses a command interface (for example a Command Line Interface, CLI, or Simple Network Management Protocol, SNMP) which triggers the appropriate commands on each node.

One of the many scenarios in which the updating of configuration parameters can be applied consists of the situation in which the software version of the network nodes needs to be updated from an old version to a new release.

For example, consider a situation applied to the particular case of a Wavelength Switched Optical Network (WSON) being migrated from a first software version (release 1.0) to a newer version of the software (release 2.0).

Once updated from release 1.0 to release 2.0 the new software works in a compatibility mode that mimics the behaviour of release 1.0 of the software.

During the migration of the network nodes from one software release to a different one (i.e. when the software running on all network nodes is not aligned) many limitations need to be put in place in order to keep, in this example, the network behavior aligned with release 1.0 until all the nodes have been migrated to release 2.0.

When the new software is running on all the nodes in the network and all the preliminary operations are performed, all network elements must be switched from the compatibility mode to a normal working mode.

Since there are many differences in the way these two software versions work, the interoperability is not granted during the time when some nodes are running as release 1.0 compatible while others are running as release 2.0, so this time frame needs to be as short as possible.

It is known to provide the command regarding the change in behaviour (i.e. software version switch) to each node using the network management system 13 of FIG. 1. However, using the NMS 13 for connection to all of the different network elements or nodes has several drawbacks. For example, such a mechanism has poor scalability—this is because a network domain with a high number of nodes results in the NMS 13 having to manage many different point-to-point connections in parallel with each node 11₁ to 11_{N}. This also implies an extremely high computational effort on the side of the NMS 13.

Such a mechanism also suffers from unacceptable time disadvantages. For example, in the event that the NMS 13 is not able to manage all the point-to-point connections with the nodes 11₁ to 11_{N} in parallel, it is necessary to perform them (or part of them) serially. This means that the misalignment in the network is much longer, as the misalignment can be considered as being completed only when all of the network nodes have been successfully switched.

Reliability is a further disadvantage of such a mechanism. In order to perform a reliable connection between the NMS 13 and each node 11₁ to 11_{N}, a mechanism for the detection of lost commands and retransmission must be used (implying computational effort and time wasted in the case of lost commands).

### SUMMARY

It is an aim of the present invention to provide a method and apparatus which obviate or reduce at least one or more of the disadvantages mentioned above.

According to a first aspect of the present invention, there is provided a method in a node of a network. The method comprises the step of receiving a configuration command signal, the configuration command signal indicating that one or more configuration parameters are to be changed in the node and at least one other node of the network. A routing protocol message is modified to include the configuration command signal. The configuration command signal is communicated to the at least one other node of the network using the modified routing protocol message.

According to another aspect of the invention, there is provided a method in a node of a network for changing one or more configuration parameters of the node, whereby the one or more configuration parameters correspond to configuration parameters that are also to be changed in at least one other node of the network. The method comprises the steps of: receiving a routing protocol message; extracting a configuration command signal contained in the received routing protocol message; and changing the one or more configuration parameters based on the extracted configuration command signal.

According to another aspect of the present invention, there is provided a node of a network. The node comprises a receiving unit coupled to receive a configuration command signal, the configuration command signal indicating that one or more configuration parameters are to be changed in the node and at least one other node of the network. The node comprises a processing unit adapted to modify a routing protocol message to include the configuration command signal, and a transmitting unit adapted to communicate the configuration command signal to the at least one other node of the network using the modified routing protocol message.

According to another aspect of the present invention, there is provided a node of a network, the node comprising one or more configuration parameters that can be changed, whereby the one or more configuration parameters correspond to configuration parameters that are also to be changed in at least one other node of the network. The node comprises a receiving unit coupled to receive a routing protocol message, a processing unit adapted to extract a configuration command signal contained in the routing protocol message, wherein the processing unit is further adapted to change the one or more configuration parameters of the node based on the extracted configuration command signal.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a known system for changing configuration parameters in one or more nodes of a network;

FIG. 2a shows a method according to an embodiment of the invention;

FIG. 2b shows a node of a network according to another embodiment of the invention;

FIG. 3a shows a method according to another embodiment of the invention;

FIG. 3b shows a node of a network according to another embodiment of the invention;

FIG. 4 shows an example of how a routing protocol message can be modified to convey a configuration command signal according to an embodiment of the invention;

FIG. 5 shows another example of how a routing protocol message can be modified to convey a configuration command signal according to another embodiment of the invention;

FIG. 6 shows another example of how a routing protocol message can be modified to convey a configuration command signal according to another embodiment of the invention;

FIG. 7 shows another example of how a routing protocol message can be modified to convey a configuration command signal according to another embodiment of the invention; and

FIGS. 8a to 8d show an example of how a routing protocol message can be used to change a configuration parameter in nodes of a network.

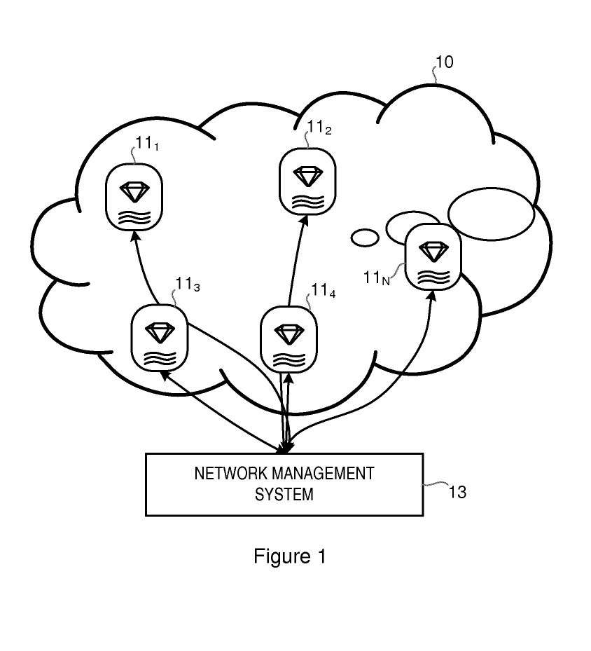

### DETAILED DESCRIPTION

The embodiments of the invention will be described below in the scenario of changing configuration parameters in the form of a software update on many network nodes. It is noted, however, that the embodiments of the invention are intended to embrace any other form of configuration change to a network node. For example, embodiments of the invention can be used in an application where different circuits can be configured with different restoration priorities, as will be described later in the application.

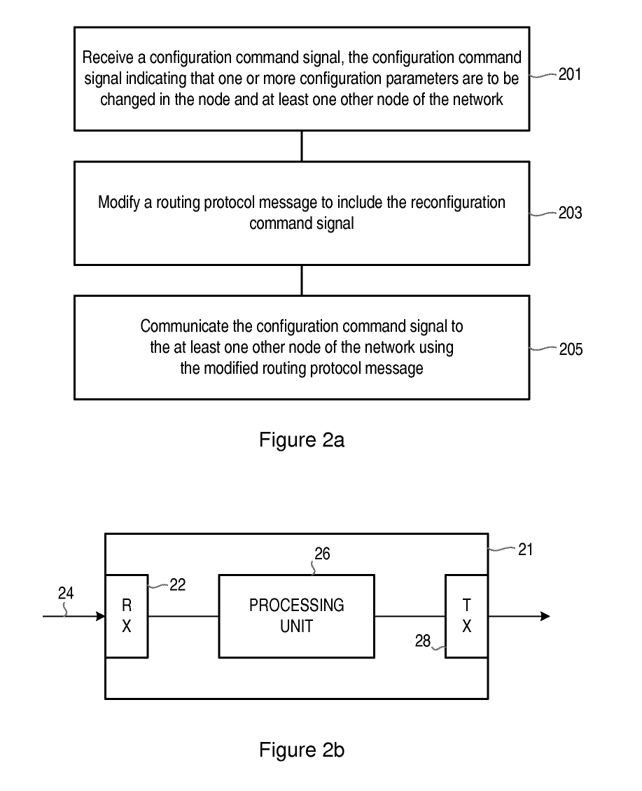

FIG. 2a shows a method performed by a node of a network according to a first embodiment of the invention. In step 201 the node receives a configuration command signal, the configuration command signal indicating that one or more configuration parameters are to be changed in the node and at least one other node of the network. In step 203 a routing protocol message is modified to include the configuration command signal. The configuration command signal is then communicated to the at least one other node of the network using the modified routing protocol message, step 205.

In this way a configuration command signal is communicated from one node to another using a routing protocol message. This has the advantage of enabling the configuration command signal to be routed to each node of a network more quickly than using a Network Management System (NMS).

The configuration command signal (or trigger signal) is therefore incorporated into a routing protocol message. By sending the configuration command signal to other nodes using the routing protocol message, this means that the command will be flooded to other nodes within a short period of time, and more reliably than using other methods, for example more reliably than using a Network Management System to send a configuration command signal to each node individually.

In addition to flooding the configuration command signal to other nodes in the flooding area, the node will also change one or more configuration parameters within the node itself, in response to receiving the configuration command signal. It is noted that the communication of the configuration command signal to one or more other nodes, and the changing of one or more configuration parameters in the node itself, may be performed in any order, or in parallel whereby they overlap to at least some extent.

According to one embodiment, the node receives the configuration command signal from a network management system, for example where the node is the first node to receive the configuration command signal, which is then to be flooded to other nodes. As such, only the one node (i.e. this node) needs to communicate with the NMS, and this node then triggers the flooding of the configuration command signal to other nodes in the network using the routing protocol messages. It is noted that the configuration command signal may be received from other sources or in other ways, for example whereby the configuration command signal is received from some form of auto-triggered event, or whereby the configuration command signal is generated upon the elapsing of a timer, or in reaction to a particular event.

It is also noted that the configuration command signal may be coded in some way, for example encrypted for security purposes.

Prior to the step of receiving a configuration command signal, the method may comprise the step of receiving information relating to the one or more configuration parameters that are to be changed in the node, wherein the one or more configuration parameters are changed in the node in response to receiving the configuration command signal.

For example, in the software update scenario described in the background section above, an embodiment of the invention is adapted to receive information relating to one or more configuration parameters that are to be changed in the node, for example information or data relating to a new software release. Each node receives the data or information relating to the new software release, but does not invoke full operation of that software release until a configuration command signal (acting as a trigger signal) is received. During this time the node may be operating in a “compatibility mode”. When the new software is running on all the nodes in the network, and any required preliminary operations have been performed (such as checking the functioning of the new software in the node), all network nodes must be switched from the compatibility mode to a normal working mode. The configuration command signal is flooded to each node in the network using a routing protocol mechanism, the configuration command signal acting as a trigger signal for switching operation of the node from the old release software to the new release software (the configuration command signal thereby indicating that one or more configuration parameters are to be changed in the node).

This enables all of the nodes in the network to be updated from an old software compatibility mode to a new software mode in a short period of time, even if some nodes are not directly reachable by the network management system via the management connection network.

For certain configuration changes, all of the information required for the configuration change can be conveyed in the routing protocol message.

However, since the routing protocol mechanism per se may not be best suited for sending large amounts of information or data associated with a new software release, this type of information can be received beforehand by each of the nodes in the network (i.e. being the one or more configuration parameters that need to be changed), prior to receiving the configuration command signal itself, and only acted upon when the configuration command signal is subsequently received.

In this way the bulk of the update information or data can be sent to each node in a non urgent way, for example using conventional techniques such as using a network management system, with the routing protocol mechanism only being used to trigger the operation of the new configuration parameters in each node. It is noted that the configuration command signal may comprise one of a series of configuration command signals that are sent using the routing protocol mechanism. For example, once a new software version has been downloaded to each node, a first configuration command signal can be used to trigger each node to operate in a compatibility mode (or test mode), with a subsequent configuration command signal then being used to trigger each node to switch to using the new software in a normal working mode. Such an embodiment can be used in an application whereby software running modules can be changed at runtime, with the configuration command signal effectively providing a command such as “change module X.v1 to X.v2 compatible”. In an example of another application, the configuration command signal can be a form of “reboot to new software release” command that is issued after downloading the new software and the new software automatically starting to work in compatibility mode.

FIG. 2b shows a node of a network according to an embodiment of the present invention. The node 21 comprises a receiving unit 22 coupled to receive a configuration command signal 24, the configuration command signal 24 indicating that one or more configuration parameters are to be changed in the node and at least one other node of the network. A processing unit 26 is adapted to modify a routing protocol message to include the configuration command signal. A transmitting unit 28 is adapted to communicate the configuration command signal to the at least one other node of the network using the modified routing protocol message.

The receiving unit 22 may be coupled to receive the configuration command signal 24 from a network management system, for example when the node 21 is a node which instigates or triggers the flooding of a configuration command signal through nodes of the network. As such, only the one node (i.e. this node) needs to communicate with the NMS, and this node then triggers the flooding of the command to other nodes.

The receiving unit 22 may be coupled to receive information relating to the one or more configuration parameters that are to be changed in the node prior to receiving the configuration command signal 24 itself, with the processing unit 26 being adapted to change the one or more configuration parameters in response to receiving the configuration command signal. As noted above, the configuration command signal may be received from other sources, or in response to other events which occur, or the lapsing of a timer.

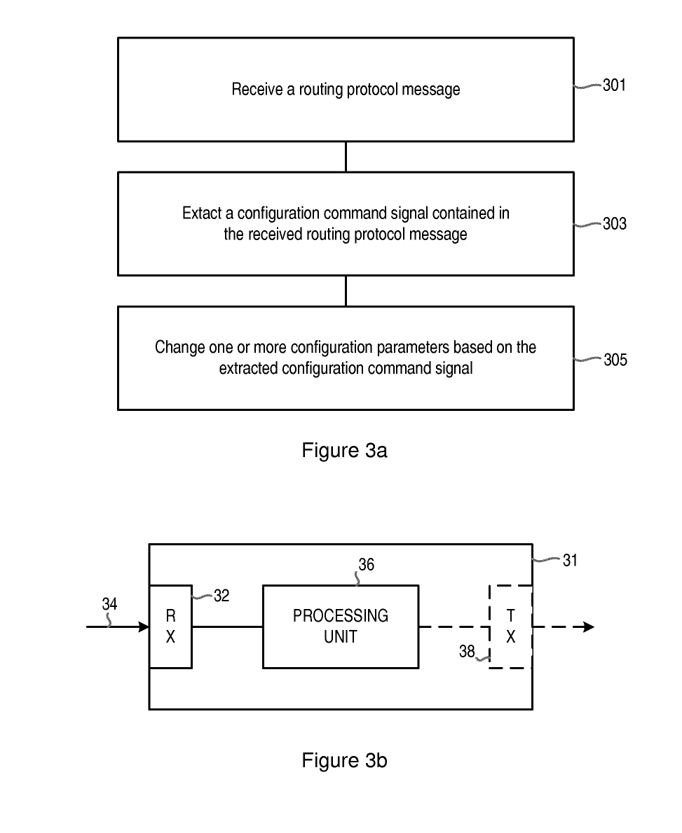

FIG. 3a shows the steps performed in a node of a network according to another embodiment of the present invention, for changing one or more configuration parameters of the node, whereby the one or more configuration parameters correspond to configuration parameters that are also to be changed in at least one other node of the network. The method relates to a method that may be performed in one of a plurality of nodes in a network that receive a configuration command signal via a flooding mechanism (i.e. as opposed to a node that instigates the flooding of a configuration command signal). In step 301 a routing protocol message is received. A configuration command signal contained in the received routing protocol message is extracted in step 303. One or more configuration parameters are changed based on the extracted configuration command signal, step 305.

The method may further comprise the step of communicating the received routing protocol message to at least one other node of the network.

Prior to the step of receiving a configuration command signal, the method may comprise the step of receiving information relating to the one or more configuration parameters that are to be changed in the node, wherein the one or more configuration parameters are changed in response to receiving the configuration command signal.

Therefore, as with the method of FIG. 2a, if the routing protocol per se is not suited to send large amounts of information, the configuration parameters themselves (for example information or data relating to a new software version) can be received prior to receiving the configuration command signal, and only acted upon when the configuration command signal is received.

The one or more other nodes of the network form part of the same flooding area of the routing protocol. As such, the configuration command signal (in the routing protocol message) is sent to the other nodes which form part of the same flooding area.

FIG. 3b shows a node of a network according to another embodiment of the present invention. The node 31 comprises one or more configuration parameters that can be changed, whereby the one or more configuration parameters correspond to configuration parameters that are also be changed in at least one other node of the network. As with FIG. 3a, the node may be one of a plurality of nodes in a network that receive a configuration command signal via a flooding mechanism (i.e. as opposed to a node that instigates the flooding of a configuration command signal). The node comprises a receiving unit 32 coupled to receive a routing protocol message 34. A processing unit 36 is adapted to extract a configuration command signal contained in the routing protocol message 34. The processing unit 36 is further adapted to change the one or more configuration parameters of the node based on the extracted configuration command signal.

The node 31 may comprise a transmitting unit 38 for communicating the configuration command signal to one or more other nodes in the network, for example whereby the node acts as a form of intermediate node. In such an embodiment, i is noted that the communication of the configuration command signal to one or more other nodes, and the changing of one or more configuration parameters in the node itself, may be performed in any order, or in parallel whereby they overlap to at least some extent.

According to one embodiment, the received routing protocol message comprises a link state advertisement, LSA, object that is provided for conveying the configuration command signal. The LSA object is a new LSA that is provided specifically for conveying the configuration command signal. Using a new LSA has the advantage that existing routing protocols running on the nodes will disregard the new LSA object because it will be of an unknown type—thus acting as an “opaque” LSA.

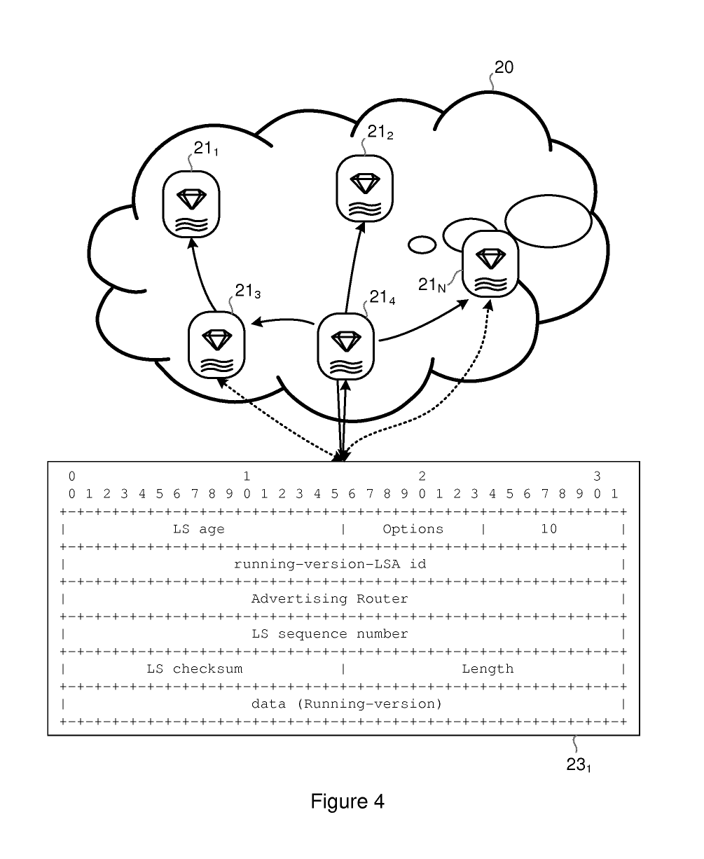

FIG. 4 shows an example of an embodiment in which a configuration command signal is conveyed using a new LSA 23₁. A new LSA, for example a Type 10 LSA, is created on each node 21₁ to 21_{N} of the network 20 with the new software version, and the new LSA contains relevant information about the software version running at a particular moment. The LSA 23₁ contains an identifier field, shown as “running-version-LSA id” in FIG. 4, identifying which software version is running at a particular moment. This can be a scalar value, such as:
1=running version 1
2=running version 2

Each node, for example a router node, generates one running-version-LSA-id. Any of the nodes 21₁ to 21_{N} running a routing protocol with the older software version will discard the LSA object because it will be of an unknown type. At a given time, after all the nodes are running the new software version, a network management system (not shown) can trigger on a node, for example node 21₄, the configuration command signal needed to switch from the compatibility mode software to the new software. This action will be reflected in the content of the new LSA (i.e. by changing the value of the running-version-LSA), and this LSA will be flooded to the whole routing area from the node 21₄. Each of the other nodes that receive the LSA with the indication of new software mode will process the LSA and automatically change the operation mode from old software compatibility mode to the new software mode (sending the new software indication too).

Certain fields of the LSA 23₁ are provided by the Open Shortest Path First (OSPF) specification. The first row having fields “LS age”, “Options” and “10” show that the LSA is of “type 10” and corresponds to “opaque with routing area flooding scope” as described in further detail in RFC 5250. Link-state type 10 denotes an area-local scope, whereby opaque LSAa are not flooded beyond borders of their associated area.

The fields relating to “Advertising Router”, “LS sequence number”, “LS checksum” and “Length” relate to fields from chapter 12 of RFC 2328, and also corresponds to the format of an opaque LSA according to RFC 5250.

The additional fields actively used to perform a configuration change according to embodiments of the invention are:

1. The field relating to “running-version-LSA id” in combination with the LS type, which is used to understand what this LSA is meant for (for example a software change configuration), and
2. the “data (running version)” field, which is used to understand what you have to do (for example providing details of the running version of a software).

The “running-version-LSA id” field is an LS identifier, chosen by a designer to identify this kind of opaque LSA. The data format is decided by the designer in an appropriate way (for example, in an embodiment of the invention this might just be an enumerated value or a string or any appropriate complex structure).

The other fields are used for internal OSPF management of this object.

According to another embodiment, the received routing protocol message comprises a new type of Traffic Engineering LSA, (TE LSA) for conveying the configuration command signal. The data section of the new type of TE LSA is therefore provided to support this new feature of conveying a configuration command signal. As above, the routing protocols running on the nodes will disregard the new type of TE LSA since it will be of an unknown type.

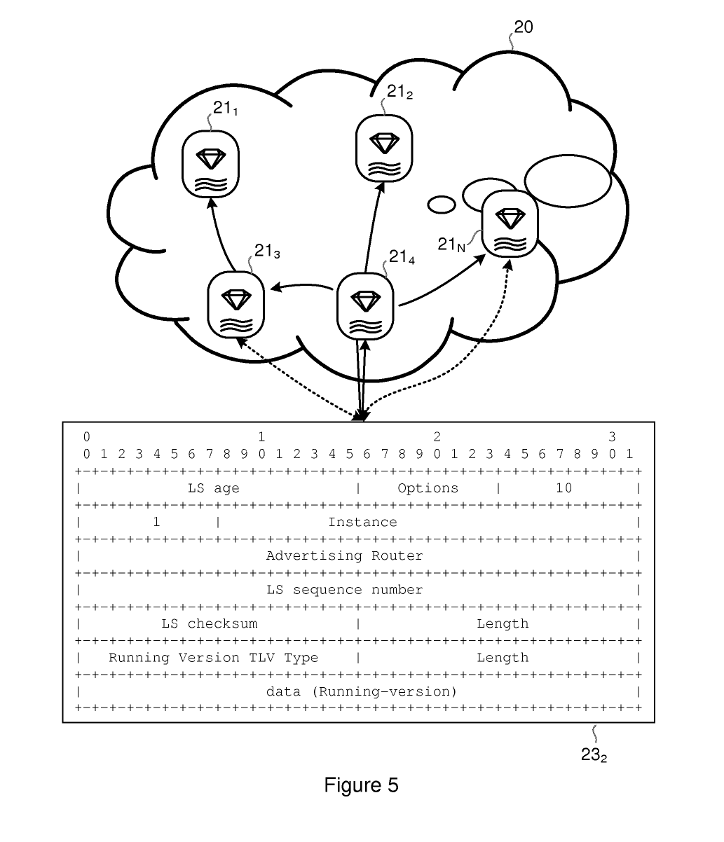

FIG. 5 shows an example of an embodiment in which a configuration command signal is conveyed using a new TE LSA 23₂. Different types of TE LSAs are provided for OSPF-TE, and the definition of a new TE LSA is carried out to enhance the protocol behavior with the newly supported feature of being able to convey configuration command signals. As in the previous embodiment, the routing protocol will ignore the new TE LSA since it will be of an unknown type. The behavior of the software after the first node 21₄ changes software version is the same as in the previous embodiment. In this embodiment the TLV payload is effectively the same as the running version value of the previous example.

As above RFC 5250 defines the opaque LSAs (and assigns the LS types 9-10-11 to opaque LSAs). RFC 3630 defines TE LSAs and opaque type 10 LSAs with the upper 8 bits of the LS ID set to 1. The remaining 24 bits are used to identify an instance of a certain TE LSA.

The use of the TE LSA is specified in the field Type that here has the value of “Running Version TLV Type”. As such, the fields relating to “Running Version TLV type” and “data (Running version)” are used by this embodiment to convey a configuration command signal in a routing protocol message.

According to another embodiment, the received routing protocol message comprises a new type-length-value, TLV, object for conveying the configuration command signal, wherein the new TLV object forms part of a link state advertisement, LSA, already being used by the routing protocol of the network (for example the running version TLV can be a sub-TLV of the existing TE LSA containing a top level TLV named “node attribute” from RFC 5786). A new TLV is therefore provided to support this new feature of conveying a configuration command signal. As above, the routing protocols running on the nodes will disregard the new TLV since it will be of an unknown type.

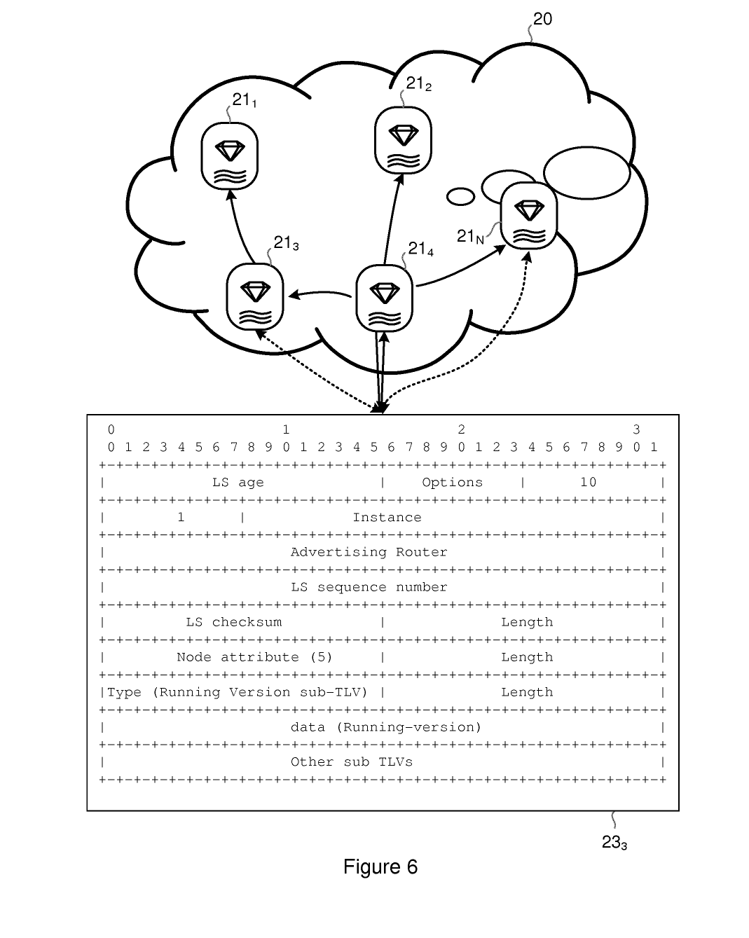

FIG. 6 shows an example of an embodiment in which a configuration command signal is conveyed using a new TLV in an existing LSA 23₃. Different TLVs already exist for the various OSPF-TE LSAs and the definition of a new TLV is carried out to enhance the protocol behavior with the newly supported feature of being able to convey configuration command signals. As in the previous embodiment, the routing protocol will ignore the new TLV since it will be of an unknown type. The behaviour of the software after the first node 21₄ changes software version is the same as in the previous embodiment. In this embodiment the TLV payload is the effectively the same as the running version value of the previous example.

It is noted that TLVs are nested. In this TE LSA the external TLV is the “node attribute TLV”. This gives the name to the TE LSA. Inside the top level TLV (type 5, node attribute) there are one or more sub-TLVs (every TLV has the same structure, sub- and top level are attributes used to identify the inner TLVs and their container). One of these sub-TLVs can be used as the “running version TLV” of the present embodiment.

According to another embodiment, the received routing protocol message comprises a reserved field of an existing type-length-value, TLV, object for conveying the configuration command signal, wherein the existing TLV object forms part of a link state advertisement, LSA, being used by the routing protocol of the network. Reserved fields of “existing” TLVs are usually ignored, so this embodiment exploits such reserved fields of existing TLVs to convey the configuration command signal.

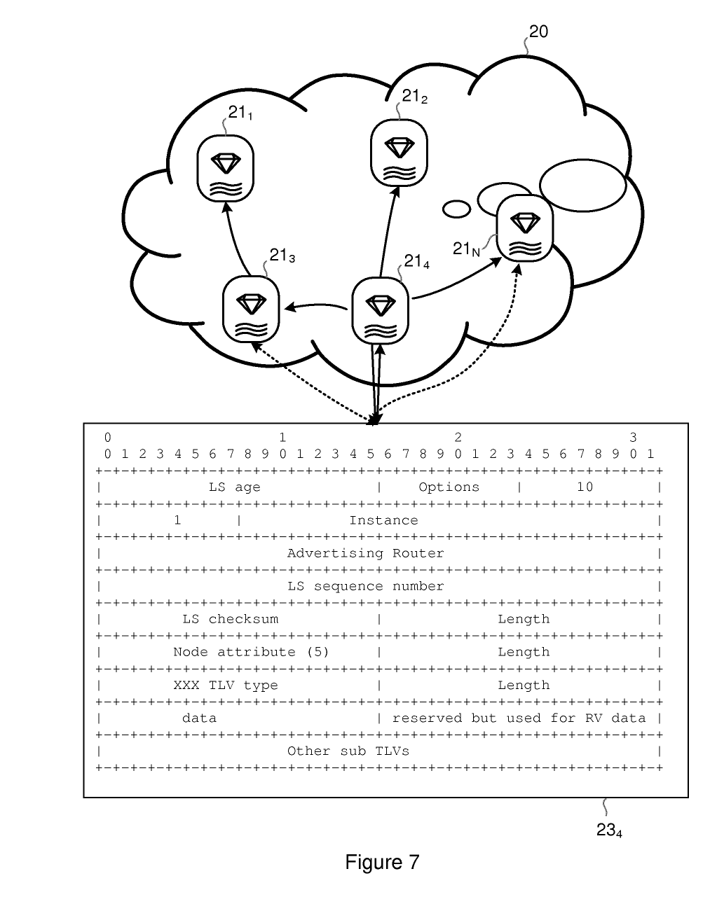

FIG. 7 shows an example of an embodiment in which a configuration command signal is conveyed using a reserved field of an existing TLV of an existing LSA 23₄. Given that reserved fields of already existing TLV are set to “0” on transmission and ignored on reception, it is possible to exploit them for the purpose of conveying a configuration command signal. For example, because a new release of software knows that there is some data in this field, it therefore looks for this data. The field is set to “0” by old nodes and set to a value different from “0” from new nodes. Old nodes do not look at the field while new nodes can process the field according to the new policy.

For example, in this embodiment, if the old software version supports a field in an existing TLV that is reserved, it is possible to use this field in order to flood the information about the software version in use. If a field in a TLV is configured as reserved in a software version its content will be ignored by all the routers so the old software will ignore the content while the new one will use it properly. The behavior of the software after the first node changes working mode is the same as in the “New LSA” embodiment described above. Acting as described above, all of the nodes will be updated from an old software compatibility mode to a new software mode in a short lapse of time, even if some of the nodes are not directly reachable by a network management system via the management connection network.

From the embodiments described above it can be seen that, in addition to performing routing operations, routing protocols are used in a network to exchange configuration command signal(s) between network nodes or elements of a network managed via a control plane. For example, routing protocols such as Open Shortest Path First (OSPF) or Intermediate System to Intermediate System (IS-IS) can be used in Generalized Multi Protocol Label Switching (GMPLS) networks in order to exchange information between the network elements.

Routing protocols extensions, called OSPF-Traffic Engineering (OSPF-TE) or IS-IS-Traffic Engineering (IS-IS-TE), have been defined to reflect the capability of also being able to advertise Traffic Engineering information. For example the information provided by the routing protocol in a wavelength division multiplexed (WDM) network is more detailed than the one used in PSC (Packet Switching Capable) or TDM (Time Division Multiplexing) networks, as physical impairments play a key role in the computation of the paths. The objects used can have the same format and follow the same rules as those described above according to embodiments of the invention. Further information about TE LSAs can be found in RFC 3630.

In the embodiments described herein the routing protocols are designed to flood configuration command signals to network nodes or elements of a network, this information being opaque to the routing protocol itself. Using this capability, the embodiments of the invention are configured to transport information between the different nodes, for processing by specific modules running on a network element or node for a particular purpose.

In this way, the use of the routing protocols in the embodiments of the invention make it possible to synchronize all of the network elements automatically (i.e. sending the same command to all of them) using the routing protocol flooding mechanism.

The use of the routing protocol mechanism has advantages over sending the command to each node using, for example, a network management system, since the routing protocol runs on a dedicated Signaling Connection Network (SCN—which is part of the Data Communication Network, DCN, dedicated to the control plane). The SCN is configured with a good redundancy level so that the probability of failure in the SCN is lower than the MCN used by a network management system.

It is also noted that, even if a node is turned off, the node will be updated as soon as it comes back up without any other action by a network management system.

The embodiments of the invention enable a network management system to trigger the appropriate commands on a single node, and that same node will update all of the other nodes of the network via the routing protocol.

As described above, it is possible to carry a configuration command signal (for example a “trigger upgrade” signal in the particular case of a software upgrade) via a new LSA, a new TE LSA, a new TLV inside an existing LSA or exploiting a reserved field of an already existing TLV object. It is noted that these are examples only, and that other mechanisms for conveying configuration command signals within a routing protocol message are also intended to be embraced by embodiments of the invention.

The use of a routing protocol mechanism has the advantage that, even if a node is disabled or turned off the information will reach the node as soon as it comes back online, and in a time frame compatible with the one needed by the node to be able to participate in the rerouting of a circuit. Using this method, as soon as the node is able to make some LSP rerouting it will also be able to know that the working mode is now compatible with the new software version.

This method leads to a reduced time of misalignment in the working mode of the nodes of a network, for example when upgrading from an old software version to a new software version.

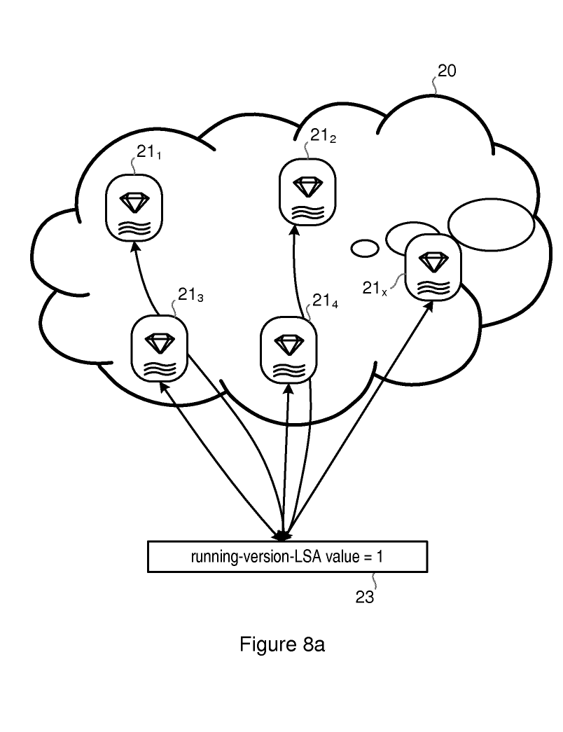

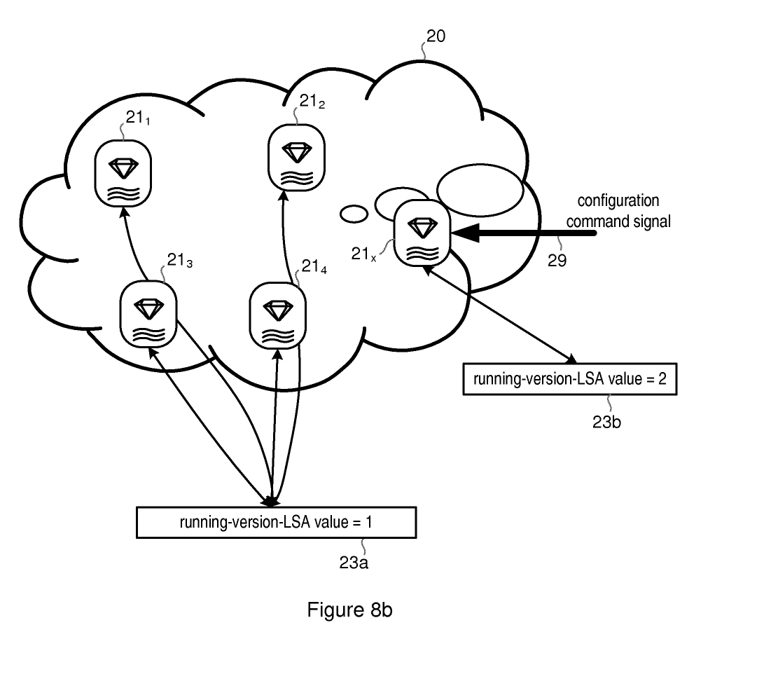

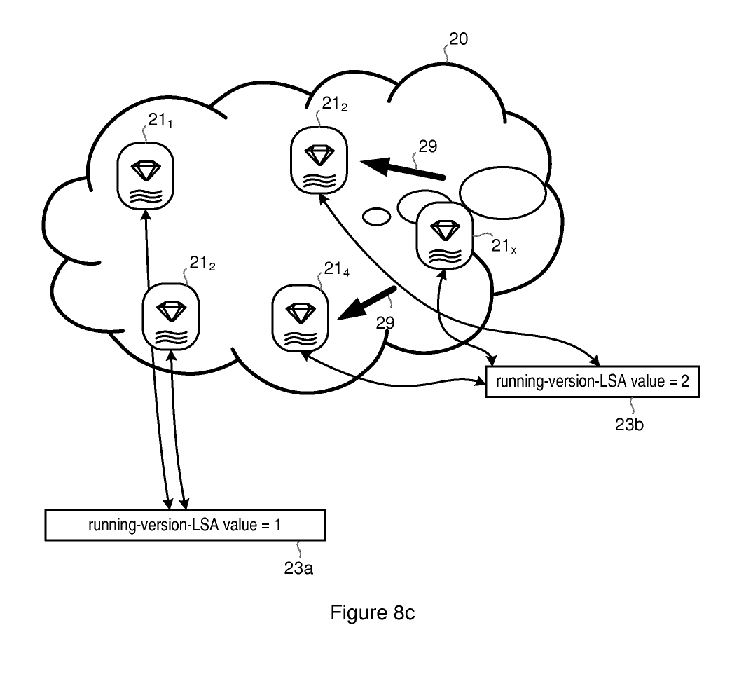

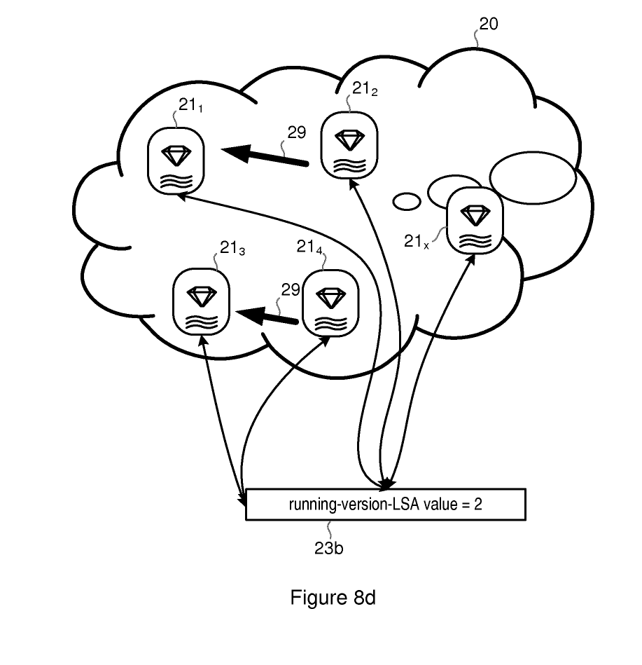

FIGS. 8a to 8d describe an example of how a software update can be carried out in different nodes of a network.

FIG. 8a shows an initial status of a network 20, in which an LSA is shown as indicating that the running version of the software is version 1 (i.e. running-version-LSA value=1). Therefore, all nodes 21₁ to 21_{N} operate using version 1 of the software.

In FIG. 8b, one of the nodes 21ₓ is shown as receiving a configuration command signal 29 (for example from a network management system, not shown). The node 21ₓ is adapted to modify a routing protocol message, for example indicating in an LSA 23b that the running version of the software is to be version 2 (by changing or modifying the LSA such that running-version-LSA value=2).

Referring to FIG. 8c, the node 21ₓ floods the new LSA comprising the configuration command signal 29 to the nodes 21₂ and 21₄ using the routing protocol mechanism, such that nodes 21₂ and 21₄ are also switched to running version 2 of the software as soon as an LSA reporting “running-version-LSA=2” is received. Each node updates its own LSA, and continues flooding the received routing protocol message.

Referring to FIG. 8d, nodes 21₂ and 21₄ in turn flood the LSA comprising the configuration command signal 29 to nodes 21₁ and 21₃ using the routing protocol mechanism, such that nodes 21₁ and 21₂ also switch to running version 2 of the software. When the flooding is over the whole network has been switched to running version 2 of the software.

Each node describes its status in an object that can be flooded using the methods described above, for example a “running version” status. When a node receives a running version status inside an LSA from another node, the node performs the following functions. First, the node processes the received LSA as usual. This means it will be flooded according to its characteristics. For example TE LSAs are flooded on the whole routing area so the received LSA is send to all the neighbour (==connected) routers who do not already have it and belong to the same routing area the LSA was received from. Second, the node processes the content of the LSA. This means that the node triggers the change of configuration as instructed, and changes the content of its own running version status and regenerates its own LSA containing that information and floods it according to the flooding rules. In the end, if one of the TE LSA methods is used, any routers in the routing area will advertise itself as running version 2 of the software. Each router will know that all of the routers are running version 2 because its database will contain the information generated by all the routers.

From the above it can be seen that one or more configuration parameters in a node, such as software version, can be changed in all of the nodes in the network using the routing protocol message, in a quick and reliable manner.

Although the embodiments of the invention have been described as receiving the initial configuration command signal (trigger signal) from a network management system, it is noted that this signal may also be received from another source or sources.

Furthermore, although the embodiments of the invention have been described in the scenario of changing configuration parameters in the form of a software update on many network nodes, it is noted that the embodiments of the invention are intended to embrace any other form of configuration change to a network node.

One example of such another use is where different circuits can be configured with different restoration priorities. In such an application it is possible to associate each priority with a delay in the restoration process so that circuits with lower priority are restored when circuits with a high priority have already been successfully restored. Thus, when a failure occurs the circuits affected are rerouted at different times and this happens on each ingress node. Each node has a configuration that associates the delay to be applied to each priority (for example priority-0:0 ms, priority-1:300 ms, priority-2:600 ms . . . etc) and in order to have the network behave as expected the configuration of all of the nodes must be the same because otherwise there can be a situation in which circuits with low priority routed from node X steal resources to circuits with high priority rerouted by node Y (for example, Node X priority-0:0 priority-1:300 priority-2:600 . . . ; node Y priority-0:0 priority-1:1000 ms priority-2:2000 ms . . . ). Other applications are also intended to be embraced.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method in a node of a network, the method comprising the steps of:
receiving a configuration command signal, the configuration command signal indicating that one or more configuration parameters are to be changed in the node and at least one other node of the network;
modifying a routing protocol message to include the configuration command signal; and
communicating the configuration command signal to the at least one other node of the network using the modified routing protocol message.

2. A method as claimed in claim 1, wherein the configuration command signal is received from a network management system.

3. A method as claimed in claim 1, wherein prior to the step of receiving a configuration command signal, the method comprises the step of receiving information relating to the one or more configuration parameters that are to be changed in the node, wherein the one or more configuration parameters are changed in the node in response to receiving the configuration command signal.

4. A method in a node of a network for changing one or more configuration parameters of the node, whereby the one or more configuration parameters correspond to configuration parameters that are also to be changed in at least one other node of the network, the method comprising the steps of:
receiving a routing protocol message;
extracting a configuration command signal contained in the received routing protocol message; and
changing the one or more configuration parameters based on the extracted configuration command signal.

5. A method as claimed in claim 4, further comprising the step of communicating the received routing protocol message to at least one other node of the network.

6. A method as claimed in claim 4, wherein prior to the step of receiving a configuration command signal, the method comprises the step of receiving information relating to the one or more configuration parameters that are to be changed in the node, wherein the one or more configuration parameters are changed in response to receiving the configuration command signal.

7. A method as claimed in claim 1, wherein the one or more other nodes of the network form part of the same flooding area of the routing protocol.

8. A method as claimed in claim 1,
wherein the received routing protocol message comprises a new link state advertisement (LSA) or a new traffic engineering link state advertisement (TE LSA) that is provided for conveying the configuration command signal.

9. A method as claimed in claim 1, wherein the received routing protocol message comprises a new type-length-value (TLV) object for conveying the configuration command signal, wherein the new TLV object forms part of an existing link state advertisement (LSA) being used by the routing protocol of the network.

10. A method as claimed in claim 1, wherein the received routing protocol message comprises a reserved field of an existing type-length-value (TLV) object for conveying the configuration command signal, wherein the existing TLV object forms part of a link state advertisement (LSA) being used by the routing protocol of the network.

11. A method as claimed in claim 1, wherein a routing protocol message is received and/or sent over a dedicated signaling connection network (SCN) of a routing protocol mechanism.

12. A node of a network, the node comprising:
a receiving unit coupled to receive a configuration command signal, the configuration command signal indicating that one or more configuration parameters are to be changed in the node and at least one other node of the network;
a processing unit adapted to modify a routing protocol message to include the configuration command signal; and
a transmitting unit adapted to communicate the configuration command signal to the at least one other node of the network using the modified routing protocol message.

13. A node as claimed in claim 12, wherein the receiving unit is coupled to receive the configuration command signal from a network management system.

14. A node as claimed in claim 12, wherein the receiving unit is coupled to receive information relating to the one or more configuration parameters that are to be changed in the node prior to receiving the configuration command signal, wherein the processing unit is adapted to change the one or more configuration parameters in response to receiving the configuration command signal.

15. A node of a network, the node comprising one or more configuration parameters that can be changed, whereby the one or more configuration parameters correspond to configuration parameters that are also to be changed in at least one other node of the network, the node comprising:
a receiving unit coupled to receive a routing protocol message;
a processing unit adapted to extract a configuration command signal contained in the routing protocol message; and
wherein the processing unit is further adapted to change the one or more configuration parameters of the node based on the extracted configuration command signal.

16. A node as claimed in claim 15, further comprising:
a transmitting unit adapted to communicate the received routing protocol message to one or more other nodes in the network.

17. A node as claimed in claim 15, wherein the receiving unit is coupled to receive information relating to the one or more configuration parameters that are to be changed in the node prior to receiving the configuration command signal, and wherein the processing unit is adapted to change the one or more configuration parameters in response to receiving the configuration command signal.

18. A node as claimed in claim 16, wherein the transmitting unit is adapted to communicate the routing protocol message to one or more other nodes in the network that form part of the same flooding area of the routing protocol.

19. A node as claimed in claim 12, wherein the receiving unit is coupled to receive a routing protocol message comprising a link state advertisement (LSA) or a new traffic engineering link state advertisement (TE LSA) that is provided for conveying the configuration command signal.

20. A node as claimed in claim 12, wherein the receiving unit is coupled to receive a routing protocol message comprising a new type-length-value (TLV) object for conveying the configuration command signal, wherein the new TLV object forms part of a link state advertisement (LSA) being used by the routing protocol of the network.

21. A node as claimed in claim 12, wherein the receiving unit is coupled to receive a routing protocol message comprising a reserved field of an existing type-length-value (TLV) object for conveying the configuration command signal, wherein the existing TLV object forms part of a link state advertisement (LSA) being used by the routing protocol of the network.

22. A method as claimed in claim 4, wherein the one or more other nodes of the network form part of the same flooding area of the routing protocol.

23. A method as claimed in claim 4, wherein the received routing protocol message comprises a new link state advertisement (LSA) or a new traffic engineering link state advertisement (TE LSA) that is provided for conveying the configuration command signal.

24. A method as claimed in claim 4, wherein the received routing protocol message comprises a new type-length-value (TLV) object for conveying the configuration command signal, wherein the new TLV object forms part of an existing link state advertisement (LSA) being used by the routing protocol of the network.

25. A method as claimed in claim 4, wherein the received routing protocol message comprises a reserved field of an existing type-length-value (TLV) object for conveying the configuration command signal, wherein the existing TLV object forms part of a link state advertisement (LSA) being used by the routing protocol of the network.

26. A method as claimed in claim 4, wherein a routing protocol message is received and/or sent over a dedicated signaling connection network (SCN) of a routing protocol mechanism.

27. A node as claimed in claim 15, wherein the receiving unit is coupled to receive a routing protocol message comprising a link state advertisement (LSA) or a new traffic engineering link state advertisement (TE LSA) that is provided for conveying the configuration command signal.

28. A node as claimed claim 15, wherein the receiving unit is coupled to receive a routing protocol message comprising a new type-length-value (TLV) object for conveying the configuration command signal, wherein the new TLV object forms part of a link state advertisement (LSA) being used by the routing protocol of the network.

29. A node as claimed in claim 15, wherein the receiving unit is coupled to receive a routing protocol message comprising a reserved field of an existing type-length-value (TLV) object for conveying the configuration command signal, wherein the existing TLV object forms part of a link state advertisement (LSA) being used by the routing protocol of the network.
